(19) United States
(12) Patent Application Publication
(10) Pub. No.: US 2015/0234449 A1
(43) Pub. Date: Aug. 20, 2015

(54) FAST POWER GATING OF VECTOR PROCESSORS

(71) Applicant: QUALCOMM INCORPORATED, SAN DIEGO, CA (US)

(72) Inventors: Raheel Khan, Tustin, CA (US); Paul Donald Krivacek, San Diego, CA (US)

(73) Assignee: QUALCOMM INCORPORATED, SAN DIEGO, CA (US)

(21) Appl. No.: 14/181,122

(22) Filed: Feb. 14, 2014

(51) Int. Cl. G06F 1/32

(52) U.S. Cl. CPC G06F 1/3287

(57) ABSTRACT

Techniques for fast power gating of vector processors are described herein. In one embodiment, a method for power gating a vector processor comprises powering up a vector unit from an inactive state at approximately a boundary of a transmission time interval, and powering down the vector unit within the transmission time interval after the vector unit completes a task within the transmission time interval.

### BACKGROUND

1. Field

Aspects of the present disclosure relate generally to power gating, and more particularly, to fast power gating of vector processors.

2. Background

Leakage power consumption is a significant component of idle power consumption for deep sub-micron high-speed low-power circuits, and therefore needs to be minimized (e.g., to maximum battery life). A common technique for reducing leakage power consumption on a chip is to power gate one or more processors and/or functional blocks on the chip. For example, a coarse-grained power-gating technique may be used to reduce leakage power consumption by powering down a processor when it is idle. This technique is viable when the processor needs to be power-cycled relatively infrequency. In another example, a fine-grained predictive power-gating technique may be used. This technique involves monitoring instruction streams to predict which data paths in a circuit can be powered down.

### SUMMARY

The following presents a simplified summary of one or more embodiments in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later.

According to a first aspect, a method for power gating a vector processor is described herein. The method comprises powering up a vector unit from an inactive state at approximately a boundary of a transmission time interval, and powering down the vector unit within the transmission time interval after the vector unit completes a task within the transmission time interval.

A second aspect relates to an apparatus for power gating a vector processor. The apparatus comprises means for powering up a vector unit from an inactive state at approximately a boundary of a transmission time interval, and means for powering down the vector unit within the transmission time interval after the vector unit completes a task within the transmission time interval.

A third aspect relates to an apparatus for power gating a vector processor. The apparatus comprises a timing module configured to issue an interrupt request at approximately a boundary of a transmission time interval, and a processor configured to determine whether a vector unit has completed a task within the transmission time interval and to output a power-down signal upon a determination that the vector unit has completed the task. The apparatus also comprises a power unit configured to power up the vector unit in response to the interrupt request and to power down the vector unit in response to the power-down signal.

To the accomplishment of the foregoing and related ends, the one or more embodiments comprise the features hereinafter fully described and particularly pointed out in the claims. The following description and the annexed drawings set forth in detail certain illustrative aspects of the one or more embodiments. These aspects are indicative, however, of but a few of the various ways in which the principles of various embodiments may be employed and the described embodiments are intended to include all such aspects and their equivalents.

### BRIEF DESCRIPTION OF THE DRAWINGS

FIG. 1 shows a vector processor according to an embodiment of the present disclosure.

FIG. 2 shows an example of a time structure used for wireless transmissions.

FIG. 3 shows a vector processor with timing module according to an embodiment of the present disclosure.

FIG. 4 is a timing diagram showing an example of power gating of a vector unit according to an embodiment of the present disclosure.

FIG. 5 is a timing diagram showing an example in which a vector unit is power gated multiple times within a subframe according to an embodiment of the present disclosure.

FIG. 6 is a timing diagram showing an example in which a vector unit is power gated multiple times within a subframe according to another embodiment of the present disclosure.

FIG. 7 is a flow diagram of a method for power gating a vector processor according to an embodiment of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

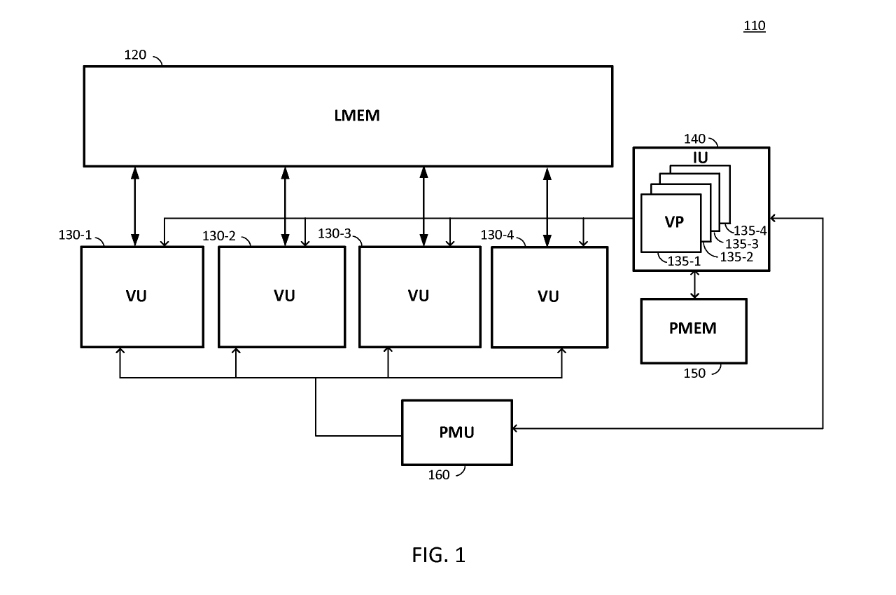

A vector processor may be used to accelerate processing of baseband signals by performing arithmetic and logic operations on data vectors, in which each data vector may comprise a plurality of data samples. FIG. 1 shows a vector processor 110 with leakage-power management according to an embodiment of the present disclosure. The vector processor 110 comprises shared memory (LMEM) 120, a plurality of vector units 130-1 to 130-4, an integer unit (IU) 140, program memory (PMEM) 150, and a power management unit (PMU) 160.

Each vector unit 130-1 to 130-4 may comprise reconfigurable data paths, logic and arithmetic devices (e.g., adders, multiplexers, accumulators) that can be programmed to perform various vector operations. For example, the vector processor 110 may be part of a modem (e.g., a Long Term Evolution (LTE) modem) of a User Equipment (UE) (e.g., a mobile wireless device). In this example, the vector units 130-1 to 130-4 may be programmed to perform various vector operations for the modem, including, for example, Fast Fourier Transform (FFT), channel estimation, demapping, demodulation, QR decomposition, etc. Each vector unit 130-1 to 130-4 is in a separate power domain, which allows the vector units 130-1 to 130-4 to be power gated independently, as discussed further below.

The IU 140 implements a plurality of virtual processors 135-1 to 135-4 in a time division manner, in which each virtual processor 135-1 to 135-4 is allocated a percentage of the IU's processing time. Each virtual processor 135-1 to 135-4 is paired with a respective one of the vector units 130-1 to 130-4, and is responsible for fetching instructions for the respective vector unit 130-1 to 130-4 from the PMEM 150, and programming the respective vector unit 130-1 to 130-4 in accordance with the instructions to perform certain vector operations. Each virtual processor 135-1 to 135-4 may also execute instructions for controlling power gating of the respective vector unit 130-1 to 130-4, as discussed further below.

Data vectors that need to be processed by the vector processor 110 are loaded into the LMEM 120. The vector units 130-1 to 130-4 have shared access to the LMEM 120. Each vector unit 130-1 to 130-4 may read a data vector from the LMEM 120 to perform one or more vector operations on the data vector, and write the resultant data vector to the LMEM 120.

The PMU 160 is configured to power gate the vector units 130-1 to 130-4. In one embodiment, each vector unit 130-1 to 130-4 may be selectively connected to a power supply by a respective power switch (e.g., head switch). In this example, the PMU 160 powers down a vector unit 130-1 to 130-4 by turning off the respective power switch, which disconnects the vector unit 130-1 to 130-4 from the power supply. The PMU 160 powers up a vector unit 130-1 to 130-4 by turning on the respective power switch, which connects the vector unit 130-1 to 130-4 to the power supply.

In one embodiment, the PMU 160 may power down a vector unit 130-1 to 130-4 if the PMU 160 receives a power-down signal for the vector unit 130-1 to 130-4 from the IU 140 (e.g., the respective virtual processor 135-1 to 135-4 implemented in the IU 140), as discussed further below. The PMU 160 may power up a vector unit 130-1 to 130-4 if the PMU 160 receives an interrupt request for the respective vector unit 130-1 to 130-4. The interrupt request may be issued by the IU 140 or a timing module, as discussed further below.

Power-gating techniques for the vector processor 110 will now be described according to various embodiments of the present disclosure. For ease of discussion, the power-gating techniques are described below using the example of the vector unit 130-1 and its respective virtual processor 135-1. However, it is to be appreciated that each vector unit 130-1 to 130-4 and respective virtual processor 135-1 to 135-4 may perform one or more of the power-gating techniques described below.

In one embodiment, a program for the vector unit 130-1 may include an instruction to power down the vector unit 130-1. When the virtual processor 135-1 executes this instruction, the virtual processor 135-1 sends a power-down signal to the PMU 160 to power down the vector unit 130-1.

In one embodiment, the instruction comprises a “wait” instruction indicating that it is time to power down the vector unit 130-1. Upon executing the “wait” instruction, the virtual processor 135-1 sends a power-down signal to the PMU 160 to power down the vector unit 130-1. The “wait” instruction may be appended to the end of a set of instructions for performing a certain task (e.g., FFT, channel estimation, demapping, etc). As a result, after the virtual processor 135-1 has programmed the vector unit 130-1 with the last instruction for the task, the virtual processor 135-1 sends a power-down signal to the PMU 160 to power down the vector unit 130-1. Techniques for powering up the vector unit 130-1 to perform the next task are discussed further below.

In one embodiment, a “sync” instruction may be inserted in the program between the set of instructions for performing the task and the “wait” instruction. When the virtual processor 135-1 executes the “sync” instruction, the virtual processor 135-1 requests, from the vector unit 130-1, a status of operations associated with previous instructions in the program (i.e., instructions for the task). The virtual processor 135-1 waits until the vector unit 130-1 indicates that the operations are completed before executing the next instruction (i.e., the “wait” instruction). This ensures that the vector unit 130-1 is not powered down until it has completed the task (e.g., the vector unit 130-1 has written the resultant data vector for the task to the LMEM 120).

In another embodiment, the “wait” instruction may be time delayed after the virtual processor 135-1 has programmed the vector unit 130-1 with the last instruction for the task. The time delay may be a predetermined delay that gives the vector unit 130-1 enough time to complete all outstanding operations associated with the task before the vector unit 130-1 is powered down. The time delay may be implemented by inserting one or more No Operation (NOP) instructions in the program between the last instruction for the task and the “wait” instruction. Each NOP instruction causes the virtual processor 130-1 to do nothing for one instruction cycle, effectively delaying execution of the “wait” instruction by one instruction cycle. An instruction cycle may equal one clock cycle. The number of NOP instructions may be chosen to achieve the desired time delay. For example, a time delay of ten instruction cycles may be achieved by inserting ten NOP operations between the last instruction for the task and the “wait” instruction.

Each of the vector units 130-1 to 130-4 may be independently powered down in the manner discussed above. More particularly, the program for each vector unit 130-1 to 130-4 may include a “wait” instruction after a set of instructions for performing a respective task. This way, each vector unit 130-1 to 130-4 may be independently powered down by the respective virtual processor 135-1 to 135-4 when the vector unit 130-1 to 130-4 completes the respective task. The vector units 130-1 to 130-4 may complete their respective tasks at different times, and therefore be powered down by their respective virtual processors 135-1 to 135-4 at different times.

Other types of instructions may also be used to indicate that it is time to power down the vector unit 130-1. For example, the virtual processor 135-1 may interpret an instruction for the vector unit 130-1 to write a resultant data vector for a task to the LMEM 120 (e.g., a write instruction) as an indication to power down the vector unit 130-1. In this example, the virtual processor 135-1 may send a power-down signal to the PMU 160 to power down the vector unit 130-1 upon executing this instruction.

As discussed above, the PMU 160 may be configured to power up the vector unit 130-1 from an inactive state when the PMU 160 receives an interrupt request for the vector unit 130-1. The interrupt request may be triggered by a wakeup event corresponding to a boundary of a transmission time interval (e.g., LTE subframe), as discussed further below.

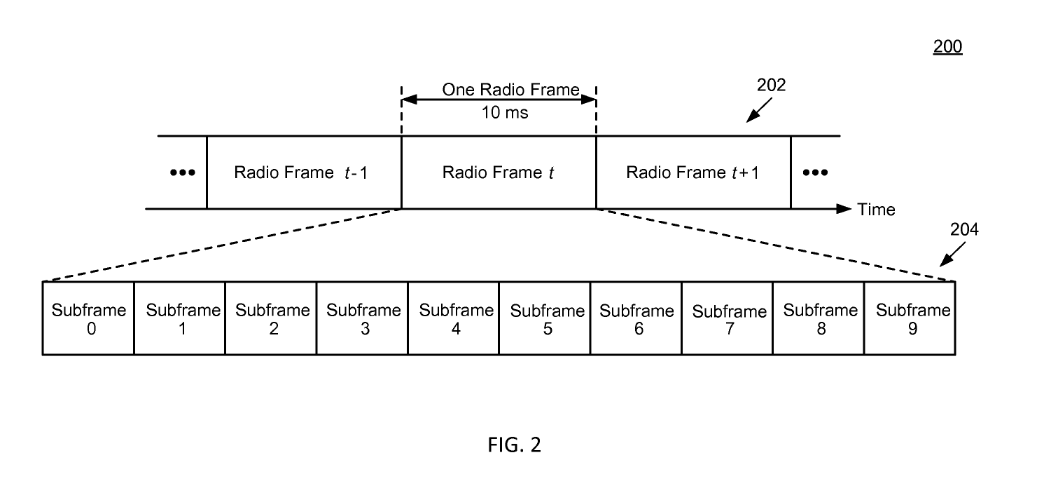

In one embodiment, the vector processor 110 may be implemented in an LTE modem of a UE that receives data and control signals from a base station (e.g., an evolved Node B (eNodeB)) via radio transmissions. In this regard, FIG. 2 shows an example of a time structure 200 for radio transmissions according to an LTE standard. The time structure 200 comprises a plurality of radio frames 202, where each frame 202 has a predetermined duration (e.g., 10 milliseconds (ms)). Each frame 202 may be partitioned into ten subframes 204 with indices of 0 through 9, where each subframe may have a duration of one ms.

During each subframe, the vector processor 110 may receive data samples from data and/or control signals received by the UE. For example, the UE may comprise a receiver (not shown) configured to process (e.g., filter, amplify, downconvert, and/or digitize) data and/or controls signals received by the UE into data samples. The receiver may output the data samples to the vector processor 110 for further processing. The data samples for each subframe may be loaded into the LMEM 120, making the data samples accessible to the vector units 130-1 to 130-4 for processing by the vector units 130-1 to 130-4.

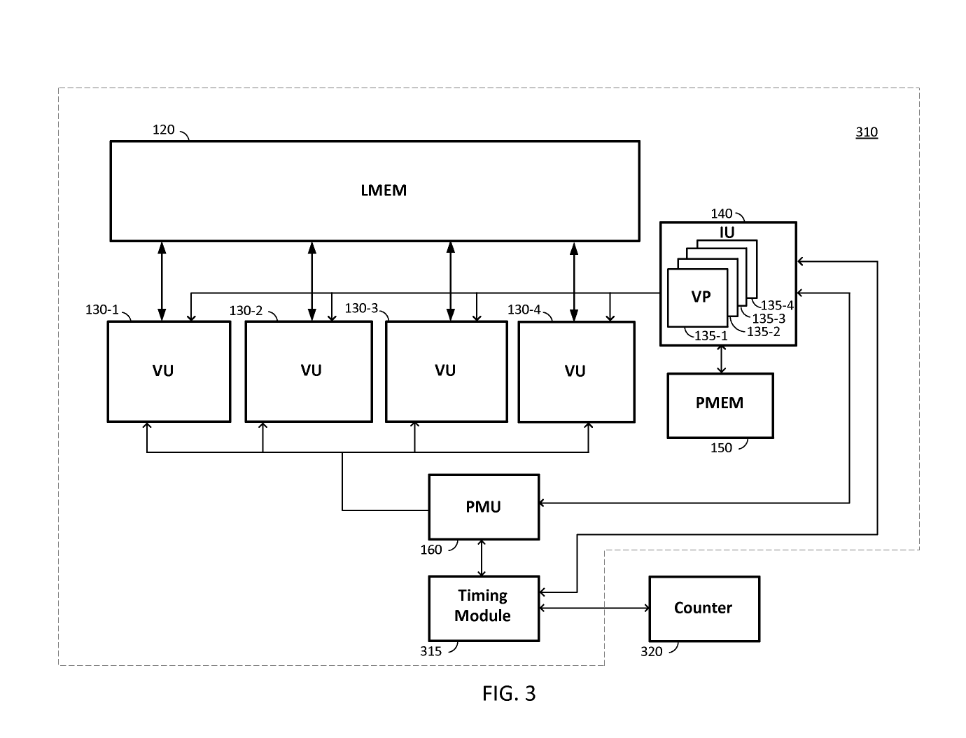

With reference to FIG. 3, the vector processor 310 may further comprise a timing module 315 configured to monitor the timing of subframes, and issue an interrupt request to the PMU 160 to power up one or more vector units 130-1 to 130-4 at approximately the first boundary (start boundary) of a subframe. To accomplish this, the timing module 315 may monitor a count value output by a counter 320, in which the count value changes at a predetermined clock frequency and indicates a system time for the UE. When the count value output by the counter 320 reaches a count value corresponding to the subframe boundary, the timing module 315 may issue the interrupt request to the PMU 160 to power up the one or more vector units 130-1 to 130-4. In this example, the UE may determine the count value corresponding to the subframe boundary based on subframe timing information provided in one or more synchronization signals received from the base station. For example, the one or more synchronization signals may comprise a Primary Synchronization Signal (PSS) and/or Secondary Synchronization Signal (SSS) received in subframes 0 and 5 of a frame 202.

In this embodiment, each time the vector unit 130-1 completes a task for a subframe, the virtual processor 135-1 may send a power-down signal to the PMU 160 to power down the vector unit 130-1. As discussed above, this may be accomplished by inserting a “wait” instruction in the corresponding program after the set of instructions for performing the task. At approximately the first boundary (start boundary) of the next subframe, the timing module 310 may send an interrupt request to the PMU 160 to power up the vector unit 130-1 to perform the task for the next subframe. Thus, each time the vector unit 130-1 completes a task for a subframe, the vector unit 130-1 may be powered down until the next subframe to reduce power consumption (e.g., power consumption due to leakage).

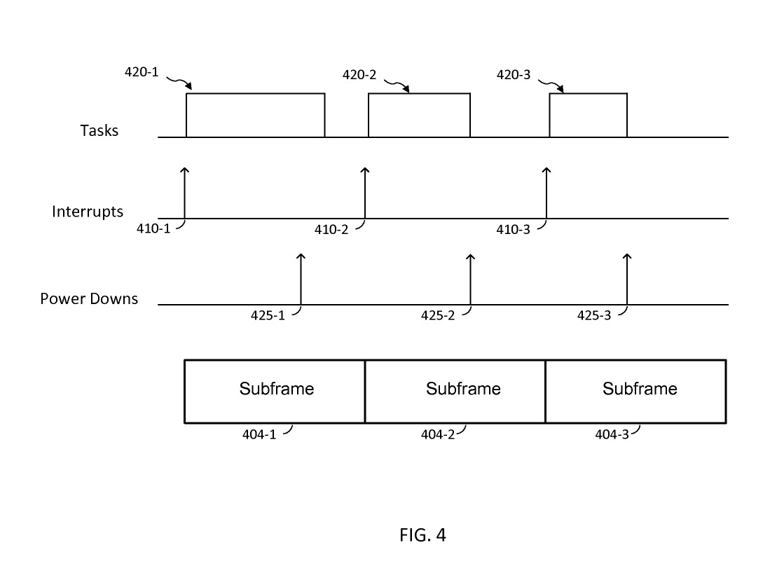

FIG. 4 shows a timing diagram illustrating an example in which a vector unit 130-1 is powered up at approximately the first boundary (start boundary) of each one of a plurality of subframes 404-1 to 404-3. In this example, the timing module 315 issues an interrupt request 410-1 to 410-3 to the PMU 160 at approximately the first boundary (start boundary) of each subframe 404-1 to 404-3 to power up the vector unit 130-1. For each interrupt request, the PMU 160 powers up the vector unit 130-1 according to a power-up sequence and sends a power-up complete signal to the virtual processor 135-1 when the power-up sequence is completed. Upon receiving the power-up complete signal, the virtual processor 135-1 may fetch instructions for performing the task for the current subframe 404-1 to 404-3 from the PMEM 150 and program the vector unit 130-1 to perform the task 420-1 to 420-3 in accordance with the instructions. When the vector unit 130-1 completes the task 420-1 to 420-3 for the current subframe 404-1 to 404-3, the virtual processor 135-1 may send a power-down signal 425-1 to 425-3 to the PMU 160 to power down vector unit 130-1. Thus, in this example, the vector unit 130-1 is powered up at the start of each subframe 404-1 to 404-3 and powered down when the task 420-1 to 420-3 for each subframe 404-1 to 404-3 is completed.

As shown in the example in FIG. 4, the durations of the tasks 420-1 to 420-3 performed by the vector unit 130-1 may vary. For example, a base station (e.g., eNodeB) may transmit different types of data signals and/or control signals in different subframes of a frame 202 (e.g., according to an LTE standard). As a result, the vector unit 130-1 may need to perform different tasks in different subframes. In another example, the base station may transmit different amounts of data in different subframes of a frame 202. As a result, the vector unit 130-1 may need to process different amounts of data samples in different subframes. Even though the durations of the tasks 420-1 to 420-3 vary, each task is completed within the duration of one subframe (e.g., one ms). In this regard, a timing analysis may be performed on the vector processor 110 to make sure that the timing constraint of one subframe is satisfied across all variations of the task-completion time.

In the examples discussed above, a wakeup event corresponds to a boundary of a subframe. It is to be appreciated that embodiments of the present disclosure are not limited to subframe boundaries, and that wakeup events may correspond to boundaries of other types of transmission time intervals, including frames, time slots, symbol periods, etc. It is also to be appreciated that embodiments of the present disclosure are not limited to LTE, and that other wireless technologies may be used including Global System for Mobile Communications (GSM), Time Division Synchronous Code Division Multiple Access (TD-SCDMA), etc.

In general, each time the vector unit 130-1 completes a task for a transmission time interval, the virtual processor 135-1 may send a power-down signal to the PMU 160 to power down the vector unit 130-1. This may be accomplished, for example, by inserting a “wait” instruction in the corresponding program after the set of instructions for performing the task. At approximately the first boundary (start boundary) of the next transmission time interval, the timing module 310 may send an interrupt request to the PMU 160 to power up the vector unit 130-1 to perform the task for the next transmission time interval. For example, the timing module 315 may monitor the count value from the counter 320 for a count value corresponding to the start of the next time interval, and issue an interrupt request to the PMU 160 when the count value corresponding to the start of the next time interval is reached.

In the examples discussed above, the vector unit 130-1 may be power gated during each transmission time interval (e.g., subframe). It is to be appreciated that the vector unit 130-1 may be powered gated with even finer granularity (i.e., power gated multiple times within a transmission time interval), as discussed further below.

For example, a task for a transmission time interval (e.g., subframe) may be divided into a plurality of smaller tasks, in which the smaller tasks are separated by time gaps. In this example, when the vector unit 130-1 completes one of the smaller tasks, the vector unit 130-1 may be powered down to conserve power. If another one of the smaller tasks needs to be performed within the transmission time interval, then the vector unit 130-1 may be powered back up within the transmission time interval to perform the other smaller task when it is time to perform the other smaller task. Thus, the vector unit 130-1 may be power gated multiple times within the transmission time interval (e.g., subframe) to perform multiple smaller tasks within the transmission time interval.

In one embodiment, data samples may be loaded into the LMEM 120 from an analog-to-digital (A/D) converter at a predetermined sampling rate. The A/D converter may be part of the receiver discussed above. In this embodiment, the vector unit 130-1 may process the data samples in batches. The vector unit 130-1 may process a batch of data samples in a shorter amount of time than it takes for the data samples for the next batch to accumulate in the LMEM 120 from the A/D converter. As a result, when the vector unit 130-1 finishes processing the batch of data samples, the vector unit 130-1 may need to wait for the data samples for the next batch to accumulate in the LMEM 120 before processing the next batch. To conserver power, the vector unit 130-1 may be powered down when the vector unit 130-1 is finished processing a batch of data samples, and may be powered back up when the next batch of data samples is ready for processing.

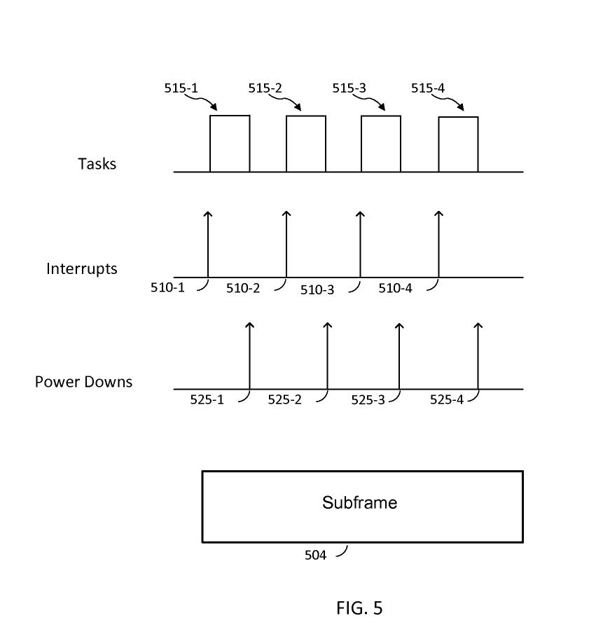

In this regard, FIG. 5 is a timing diagram illustrating an example in which a vector unit 130-1 performs multiple tasks 515-1 to 515-4 within a subframe 504. The vector unit 130-1 processes a batch of data samples in each task 515-1 to 515-4. In this example, the vector unit 130-1 may be powered up to perform each task 515-1 to 515-4 when the batch of data samples corresponding to the task 515-1 to 515-4 becomes available in the LMEM 120. The vector unit 130-1 may be powered down each time the vector unit 130-1 completes one of the tasks 515-1 to 515-4 (i.e., finishes processing the batch of data samples for the task).

In this example, the timing module 315 may monitor when a batch of data samples for a task 515-1 to 515-4 becomes available in the LMEM 120. Each time a batch of data samples becomes available, the timing module 315 may issue an interrupt request 510-1 to 510-4 to the PMU 160 to power up the vector unit 130-1. To do this, the timing module 315 may monitor the count value from the counter 320 for count values corresponding to each batch. The count value for each batch may be determined based on the number of data samples in each batch and the rate at which data samples accumulate in the LMEM 120, which is related to the sampling rate of the A/D converter. When the count value from the counter 320 reaches a count value for one of the batches, the timing module 315 sends an interrupt request to the PMU 160 to power up the vector unit 130-1. Each time the PMU 160 powers up the vector unit 130-1, the PMU 160 may send a power-up complete signal to the respective virtual processor 135-1 to indicate to the virtual processor 135-1 that the vector unit 130-1 is ready to perform the respective task.

In this example, each time the vector unit 130-1 completes one of the tasks 515-1 to 515-4, the virtual processor 135-1 may send a power-down signal 525-1 to 525-4 to the PMU 160 to power down the vector unit 130-1. This may be done, for example, by appending a “wait” instruction to the end of the instructions for each task 515-1 to 515-4. Each “wait” instruction may be preceded by a “sync” instruction to ensure that the vector unit 130-1 is not prematurely powered down, as discussed above.

In another example, a task to be performed by the vector unit 130-1 may require results (a resultant data vector) from another vector unit 130-2. For ease of discussion, the other vector unit is the vector unit 130-2, although it is to be appreciated that the other vector unit may be any one of the other vector units 130-2 to 130-4. For example, the results from the other vector unit 130-2 may be the input for the task. In this example, the vector unit 130-1 may need to wait until the results from the other vector unit 130-2 become available before performing the task. To conserve power, the vector unit 130-1 may be powered down after the previous task is completed.

When the other vector unit 130-2 outputs the results needed by the task to the LMEM 120, the virtual processor 135-2 for the other vector unit 130-2 may issue an interrupt request to the PMU 160 to power up the vector unit 130-1. To do this, the virtual processor 135-2 for the other vector unit 130-2 may determine when the other vector unit 130-2 completes an operation for writing the results to the LMEM 120, and issue the interrupt request to power up the vector unit 130-1 when the operation is completed.

Alternatively, the virtual processor 135-2 for the other vector unit 130-2 may inform the virtual processor 135-1 for the vector unit 130-1 that the results are ready. In response, the virtual processor 135-1 for the vector unit 130-1 may issue the interrupt request to the PMU 160 to power up the vector unit 130-1.

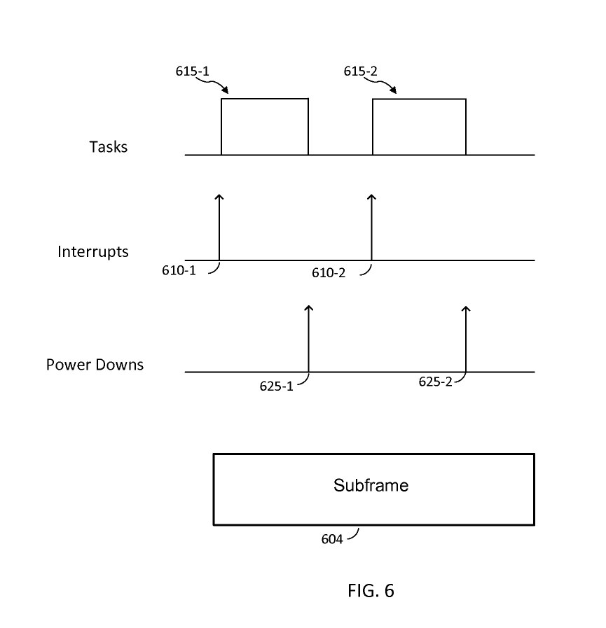

FIG. 6 is a timing diagram illustrating an example in which the vector unit 130-1 performs a first task 615-1 and a second task 615-2 within a subframe 604. In this example, the second task 615-2 requires results from the other vector unit 130-2. The timing module 315 may issue an interrupt request 610-1 to the PMU 160 at approximately the start of the subframe 604 to power up the vector unit 130-1 to perform the first task 615-1. When the vector unit 130-1 completes the first task 615-1, the respective virtual processor 135-1 may send a power-down signal 625-1 to the PMU 160 to power down the vector unit 130-1. In this example, the vector unit 130-1 is not able to perform the second task 615-2 until the results from the other vector unit 130-2 become available in the LMEM 120 (i.e., the other vector unit 130-2 writes the results to the LMEM 120).

When the other vector unit 130-2 outputs the results needed by the second task 615-2 to the LMEM 120, the virtual processor 135-2 for the other vector unit 130-2 may issue an interrupt 610-2 request to the PMU 160 to power up the vector unit 130-1. After the vector unit 130-1 is powered up, the vector unit 130-1 may perform the second task 615-2 using the results from the other vector unit 130-2, which are accessible from the LMEM 120. When the vector unit 130-1 completes the second task 615-2, the respective virtual processor 135-1 may send a power-down signal 625-2 to the PMU 160 to power down the vector unit 130-1.

Thus, embodiments of the present disclosure provide fast gating of vector processors. For instance, in some embodiments, the vector unit 130-1 may be powered gated at a rate of at least one power-gating cycle per transmission time interval (e.g., subframe). For the example of the subframes 204 in FIG. 2, which each have a duration of one ms, this translates into a power-gating rate of at least one power-gating cycle per ms. This is much faster than coarse-gain power gating techniques, in which a processor is power gated infrequency (e.g., for a sleep mode). As a result, embodiments of the present disclosure provide much finer control over power leakage.

Further, embodiments of the present disclosure power gate the vector unit 130-14 based on deterministic events. For example, in some embodiments, the vector unit 130-1 may be powered up based on the timing of subframe boundaries, which is deterministic (e.g., can be determined using a timing module).

In one embodiment, power down of the vector unit 130-1 may be prevented (aborted) if the vector unit 130-1 completes a task too close to the next wakeup event for the vector unit (e.g., next subframe, next batch of data samples, etc.). This is because the amount of energy saved by powering down the vector unit 130-1 for a very short duration may be exceeded by the amount of energy required to power the vector unit 130-1 back up, defeating the purpose of powering down the vector unit 130-1.

In one embodiment, when the virtual processor 135-1 executes an instruction to power down the respective vector unit 130-1 (e.g., a “wait” instruction), the virtual processor 135-1 may send a power-down signal to the timing module 315. Upon receiving the power-down signal, the timing module 315 may determine the amount of time (e.g., number of clock cycles) until the next wakeup event (e.g., next subframe, next batch of data samples, etc.). The timing module 315 may do this, for example, by computing the difference between the count value corresponding to the next wakeup event and the current count value from the counter 320. The timing module 315 may then compare the amount of time to a threshold value. If the amount of time is greater than the threshold, then the timing module 315 sends the power-down signal to the PMU 160. If the amount of time is equal to or less than the threshold, then the timing module 315 does not send the power-down signal to the PMU 160, in which case, the vector unit 130-1 is not powered down.

Alternatively, the above steps may be performed by the virtual processor 135-1 when the virtual processor 135-1 executes an instruction to power down the vector unit 130-1 (e.g., a “wait” instruction). In this case, the virtual processor 135-1 sends a power-down signal to the PMU 160 if the amount of time is greater than the threshold, and does not send the power-down signal if the amount of time is equal to or less than the threshold.

As discussed above, the PMU 160 powers up the vector unit 130-1 in response to an interrupt request for the vector unit 130-1. The PMU 160 may do this by initiating a power-up sequence for the vector unit 130-1, during which the voltage of the vector unit 130-1 ramps up to the power-supply voltage. The power sequence may involve varying the resistance of the power switch connecting the vector unit 130-1 to the power supply. More particularly, the resistance of the switch may be relatively high at the beginning of the power-up sequence to reduce inrush current. The resistance of the switch may then be reduced over time as the voltage of the vector unit 130-1 rises to the power-supply voltage.

When the power-up sequence is completed, the PMU 160 may send a power-up complete signal to the respective virtual processor 135-1. In response to the power-up complete signal, the respective virtual processor 135-1 may program the vector unit 130-1 to perform a task. The power-up complete signal helps ensure that the respective virtual processor 135-1 does not attempt to program the vector unit 130-1 until the vector unit 130-1 is ready.

The PMU 160 may determine when the power-up sequence is completed using a timer that indicates when a predetermined amount of time (e.g., predetermined number of clock cycles) has elapsed since the start of the power-up sequence. The predetermined amount of time may be based on the amount of time the power-up sequence is expected to take. In this aspect, the PMU 160 may send the power-up complete signal when the timer indicates that the predetermined amount of time has elapsed since the start of the power-up sequence.

Although power-gating techniques are discussed above using the example of the vector unit 130-1 and its respective virtual processor 135-1, it is to be appreciated that each vector unit 130-1 to 130-4 and respective virtual processor 135-1 to 135-4 may perform one or more of the power-gating techniques discussed above. For instance, the above description may be used to describe power techniques that may be performed by the vector unit 130-2 and respective virtual processor 135-2 by simply substituting the vector unit 130-2 and respective virtual processor 135-2 for the vector unit 130-1 and respective virtual processor 135-1 in the above description. The same holds for the vector unit 130-3 and respective virtual processor 135-3, and the vector unit 130-4 and respective virtual processor 135-4. Further, it is to be appreciated that each vector unit 130-1 to 130-4 and respective virtual processor 135-1 to 135-4 may perform one or more of the power-gating techniques independently, allowing the vector units 130-1 to 130-4 to be power gated independently.

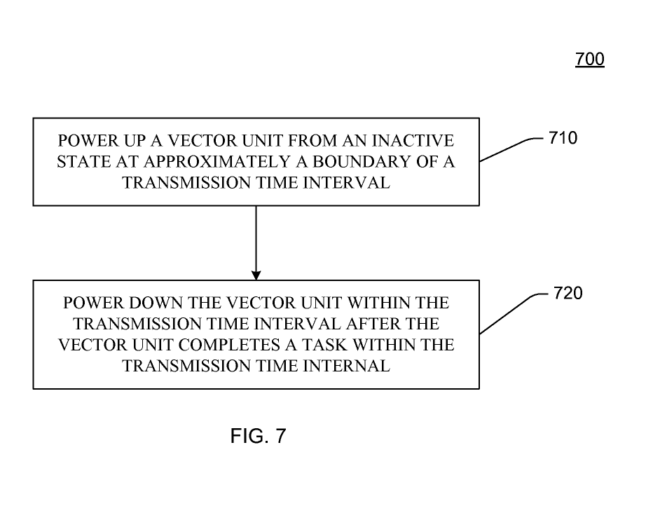

FIG. 7 is a flow diagram of a method 700 for power gating a vector processor according to an embodiment of the present disclosure.

In step 710, a vector unit is powered up from an inactive state at approximately a boundary of a transmission time interval. For example, a timing module (e.g., timing module 315) may send an interrupt signal to a PMU (e.g., PMU 160) at approximately the boundary of the transmission time interval (e.g., subframe) to power up the vector unit (e.g., vector unit 130-1).

In step 720, the vector unit is powered down within the transmission time interval after the vector unit completes a task within the transmission time interval. For example, a respective virtual processor (e.g., virtual processor 135-1) may send a power-down signal to the PMU to power down the vector unit upon executing a power-down instruction (e.g., a “wait” instruction).

It is to be appreciated that embodiments of the present disclosure are not limited to the examples discussed above. For example, the vector processor 110 may comprise separate physical processors for controlling the vector units 130-1 to 130-4 instead of virtual processors implemented in the IU 140 in a time division manner. In this example, each processor may be paired with a respective one of the vector units 130-1 to 130-4 for controlling the respective vector unit 130-1 to 130-4. Further, the power gating techniques described above according to embodiments of the present disclosure may be applied to a vector processor comprising any number of vector units.

Those skilled in the art would appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection may be properly termed a computer-readable medium to the extent involving non-transient storage of transmitted signals. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium, to the extent the signal is retained in the transmission chain on a storage medium or device memory for any non-transient length of time. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples described herein but is to be accorded the widest scope consistent with the principles and novel features disclosed herein.

What is claimed is:

1. A method for power gating a vector processor, comprising:
powering up a vector unit from an inactive state at approximately a boundary of a transmission time interval; and
powering down the vector unit within the transmission time interval after the vector unit completes a task within the transmission time interval.

2. The method of claim 1, further comprising powering up the vector unit at approximately a boundary of a second transmission time interval, wherein the second transmission time interval is adjacent to the first transmission time interval.

3. The method of claim 2, wherein each of the first and second transmission time intervals comprises a subframe.

4. The method of claim 3, wherein each subframe has a duration of approximately one millisecond.

5. The method of claim 1, further comprising:
retrieving, from a program memory, instructions for the vector unit, wherein the instructions include a set of instructions for performing the task and a power-down instruction indicating to power down the vector unit, and the power-down instruction is appended to an end of the set of instructions; and
programming the vector unit to perform the task based on the set of instructions;
wherein powering down the vector unit comprises powering down the vector unit based on the power-down instruction.

6. The method of claim 5, wherein the instructions for the vector unit include a sync instruction between the set of instructions for performing the task and the power-down instruction, and the method further comprises executing the sync instructions prior to the power-down instruction.

7. The method of claim 1, further comprising:
determining an amount of time to a next wakeup event;
comparing the amount of time to a threshold; and
determining whether to power down the vector unit based on the comparison.

8. The method of claim 1, further comprising:
determining whether resultant data from another vector unit is available in a shared memory; and
powering up the vector unit in response to a determination that the resultant data is available.

9. The method of claim 1, further comprising:
determining whether a batch of data samples is available in a memory; and
powering up the vector unit in response to a determination that the batch of data samples is available.

10. An apparatus for power gating a vector processor, comprising:
means for powering up a vector unit from an inactive state at approximately a boundary of a transmission time interval; and
means for powering down the vector unit within the transmission time interval after the vector unit completes a task within the transmission time interval.

11. The apparatus of claim 10, further comprising means for powering up the vector unit at approximately a boundary of a second transmission time interval, wherein the second transmission time interval is adjacent to the first transmission time interval.

12. The apparatus of claim 11, wherein each of the first and second transmission time intervals comprises a subframe.

13. The apparatus of claim 10, further comprising:
means for retrieving, from a program memory, instructions for the vector unit, wherein the instructions include a set of instructions for performing the task and a power-down instruction indicating to power down the vector unit, and the power-down instruction is appended to an end of the set of instructions; and
means for programming the vector unit to perform the task based on the set of instructions;
wherein the means for powering down the vector unit comprises means for powering down the vector unit based on the power-down instruction.

14. The apparatus of claim 10, further comprising:
means for determining an amount of time to a next wakeup event;
means for comparing the amount of time to a threshold; and
means for determining whether to power down the vector unit based on the comparison.

15. The apparatus of claim 10, further comprising:
means for determining whether resultant data from another vector unit is available in a shared memory; and
means for powering up the vector unit in response to a determination that the resultant data is available.

16. The apparatus of claim 10, further comprising:
means for determining whether a batch of data samples is available in a memory; and
means for powering up the vector unit in response to a determination that the batch of data samples is available.

17. An apparatus for power gating a vector processor, comprising:
a timing module configured to issue an interrupt request at approximately a boundary of a transmission time interval;
a processor configured to determine whether a vector unit has completed a task within the transmission time interval and to output a power-down signal upon a determination that the vector unit has completed the task; and
a power unit configured to power up the vector unit in response to the interrupt request and to power down the vector unit in response to the power-down signal.

18. The apparatus of claim 17, wherein the timing module is configured to issue a second interrupt request at approximately a boundary of a second transmission time interval, the power unit is configured to power up the vector unit in response to the second interrupt request, and the second transmission time interval is adjacent to the first transmission time interval.

19. The apparatus of claim 18, wherein each of the first and second transmission time intervals comprises a subframe.

20. The apparatus of claim 17, wherein the processor is further configured to:
retrieve, from a program memory, instructions for the vector unit, wherein the instructions include a set of instructions for performing the task and a power-down instruction indicating to power down the vector unit, and the power-down instruction is appended to an end of the set of instructions; and
program the vector unit to perform the task based on the set of instructions;
wherein the processor outputs the power-down signal based on the power-down instruction.
